(19) United States
(12) Patent Application Publication
(10) Pub. No.: US 2026/0197266 A1
(43) Pub. Date: Jul. 9, 2026

(54) NON-BLOCKING NETWORK-ON-CHIP TOPOLOGIES AND ROUTING

(71) Applicant: Baya Systems, Inc., Santa Clara, CA (US)

(72) Inventors: Saurabh GAYEN, Portland, OR (US); Eric NORIGE, Santa Clara, CA (US); Sailesh KUMAR, Santa Clara, CA (US)

(21) Appl. No.: 19/275,279

(22) Filed: Jul. 21, 2025

Related U.S. Application Data
(60) Provisional application No. 63/733,952, filed on Dec. 13, 2024.

(51) Int. Cl. H04L 45/02

(52) U.S. Cl. CPC H04L 45/02

(57) ABSTRACT

Aspects of the present disclosure are directed to a Network on Chip (NoC), having a layer including a plurality of routers arranged in a two-dimensional mesh, the two-dimensional mesh further having a plurality of rows and a plurality of columns, and a plurality of bridges, where each of the plurality of bridges exclusively owns a row from the plurality of rows and a column from the plurality of columns. The traffic from a source bridge of the plurality of bridges to a destination bridge of the plurality of bridges is configured to only travel across ones of the plurality of rows and the plurality of columns exclusively owned by the source bridge and the destination bridge. The use of exclusively owned rows and/or columns eliminates/minimizes blocking of traffic by other bridges aside from the source bridge and the destination bridge, thereby increasing throughput/bandwidth.

### CROSS-REFERENCE TO RELATED APPLICATIONS

This application claims priority to U.S. Provisional Application No. 63/733,952, filed on Dec. 13, 2024, the contents of which are incorporated herein by reference.

### BACKGROUND

### Technical Field

Methods and example embodiments described herein are generally directed to a Network on Chip (NoC), and more specifically, to a NoC having a topology with non-blocking routing.

### Related Art

The number of components on a chip is rapidly growing due to increasing levels of integration, system complexity, and shrinking transistor geometry. Complex System-on-Chips (SoCs) may involve a variety of components, e.g., processor cores, Digital Signal Processors (DSPs), hardware accelerators, memory, and Input/Output (I/O) interfaces, while Chip Multi-Processors (CMPs) may involve a large number of homogenous processor cores, memory, and I/O subsystems. In both systems, the on-chip interconnect plays a key role in providing high-performance communication between the various components. Due to scalability limitations of traditional buses and crossbar-based interconnects, Network-on-Chip (NoC) has emerged as a paradigm to interconnect a large number of components on the chip.

The NoC is a global shared communication infrastructure made up of several routing nodes interconnected with each other using point-to-point physical links. Messages are injected by source components and are routed from source router/nodes to a destination router/node over multiple intermediate nodes and physical links. The destination router/node then ejects the message to a destination component. For the remainder of the present disclosure, the terms ‘processing elements,’ ‘components,’ ‘endpoints,’ ‘blocks,’ ‘hosts,’ ‘agents,’ or ‘cores,’ will be used interchangeably to refer to the various system components that are interconnected using a NoC. These endpoints are attached to the core of the NoC via ‘bridges’ or ‘Network Interface Units’ (NIUs). In systems that have one bridge per endpoint, the term ‘bridge’ and ‘endpoint’ can often be used interchangeably to refer to the associated other component when this is clear. The core of the NoC is made of ‘routers’ that transport packets generated by one bridge to another bridge. The terms ‘routers’ and ‘nodes’ will also be used interchangeably. Without loss of generalization, a system with multiple interconnected components will itself be referred to as a ‘multi-core system’.

There are several possible topologies in which the routers can connect to one another to create the system network. Bi-directional rings 100A (as shown in FIGS. 1A) and 2-D mesh 100B (as shown in FIG. 1B) are examples of topologies in the related art.

Packets are message transport units for intercommunication between various components. Routing involves identifying a path, which is a set of routers and physical links of the network over which packets are sent from a source component to a destination component. Components are connected to one or multiple ports of one or multiple routers; with each such port having a unique identifier (ID). Packets carry the destination's router and port ID for use by the intermediate routers to route the packet to the destination component.

Examples of routing techniques include deterministic/static routing, which involves choosing the same path from component A to component B for every packet. This form of routing is oblivious to the state of the network and does not load balance across path diversities which may exist in the underlying network. However, such deterministic routing may be simple to implement in hardware, maintains packet ordering, and may be easy to make free of network-level deadlocks. Shortest path routing minimizes the latency as it reduces the number of hops from the source component to the destination component. For this reason, the shortest path is also the lowest power path for communication between the two components. Dimension-order routing is a form of deterministic shortest-path routing in 2D mesh networks.

FIG. 2 illustrates an example of XY routing in a two-dimensional mesh 200. More specifically, FIG. 2 illustrates XY routing from node ‘34’ to node ‘00’. In the example of FIG. 2, each component is connected to only one port of one router. A packet is first routed in the X dimension until the packet reaches node ‘04’ where the X dimension is the same as that of the destination. The packet is next routed in the Y dimension until the packet reaches the destination node.

Source routing and routing using tables are other routing options used in NoC. Adaptive routing can dynamically change the path taken between two points on the network based on the state of the network. This form of routing may be complex to analyze and implement and is therefore rarely used in practice.

The NoC may contain multiple physical networks. Over each physical network, there may exist multiple virtual networks, where different message types are transmitted over different virtual networks. In this case, at each physical link or channel, there are multiple virtual channels (VCs), each of which may have dedicated buffers at both endpoints. In any given clock cycle, only one VC can transmit data on the physical channel.

NoC interconnects often employ wormhole routing, where a large message or packet is broken into small pieces known as flits (also referred to as flow control units). The first flit is the header flit which holds information about the packet's route and key message level information along with payload data and sets up the routing behavior for all subsequent flits associated with the message. Zero or more body flits follow the head flit, containing the remaining payload of data. The final flit is a tail flit, which in addition to containing the last payload, also performs some bookkeeping to close the connection for the message. In wormhole flow control, VCs are often implemented.

The physical channels are time-sliced into a number of independent logical channels, i.e. VCs. VCs provide multiple independent paths to route packets; however, they are time-multiplexed on the physical channels. A VC holds the state needed to coordinate the handling of the flits of a packet over a channel. At a minimum, this state identifies the output channel of the current node for the next hop of the route and the state of the virtual channel (idle, waiting for resources, or active). The VC may also include pointers to the flits of the packet that are buffered on the current node and the number of flit buffers available on the next node.

The term “wormhole” refers to the way messages are transmitted over the channels. The output port at the next router can be so short that received data can be translated in the head flit before the full message arrives. This allows the router to quickly set up the route upon arrival of the head flit and then opt-out from the rest of the conversation. Since a message is transmitted flit by flit, the message may occupy several flit buffers along its path at different routers, creating a worm-like image.

Based on the traffic between various endpoints, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies. However, all channels are equal in width or number of physical wires. This width can be determined based on the most loaded channel and the clock frequency of various channels.

### SUMMARY

Aspects of the present disclosure are directed to Network on Chip (NoC). The NoC has a layer including a plurality of routers arranged in a two-dimensional mesh, and a plurality of bridges, where each of the plurality of bridges exclusively owns at least a subset of links between the plurality of routers. Further, traffic from a source bridge of the plurality of bridges to a destination bridge of the plurality of bridges is configured to only travel across ones of the subset of links exclusively owned by the source bridge and the destination bridge.

### BRIEF DESCRIPTION OF THE DRAWINGS

FIGS. 1A and 1B illustrate examples of a bidirectional ring and two-dimensional (2D) Mesh Network on Chip (NoC) topologies.

FIG. 2 illustrates an example of XY routing in a NoC having a two-dimensional mesh topology.

FIG. 3A illustrates a System on Chip (SoC) implementing a NoC, in accordance with an example implementation.

FIG. 3B illustrates a switch chip implementing a NoC, in accordance with an example implementation.

FIG. 4A illustrates a layer (design) of a NoC having dedicated rows and columns for endpoints of a switch chip, in accordance with an example implementation.

FIG. 4B illustrates another layer (design) of a NoC having dedicated rows and columns for endpoints of a switch chip, in accordance with an example implementation.

FIGS. 4C to 4H illustrate further layer (designs) of a NoC having dedicated rows and columns for endpoints of the switch chip, in accordance with an example implementation.

FIG. 5 illustrates a representation of a NoC having multiple layers extending in three-dimensions, in accordance with an example implementation.

FIGS. 6A and 6B illustrate representations of example cross-layer routers for inter-layer communication, in accordance with an example implementation.

FIGS. 7A and 7B illustrate a NoC having multiple layers connected to each other on a common plane, in accordance with an example implementation.

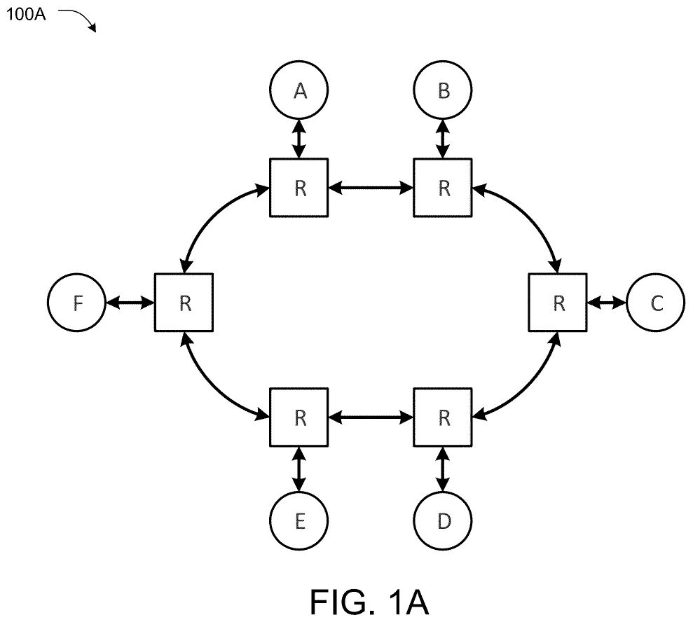

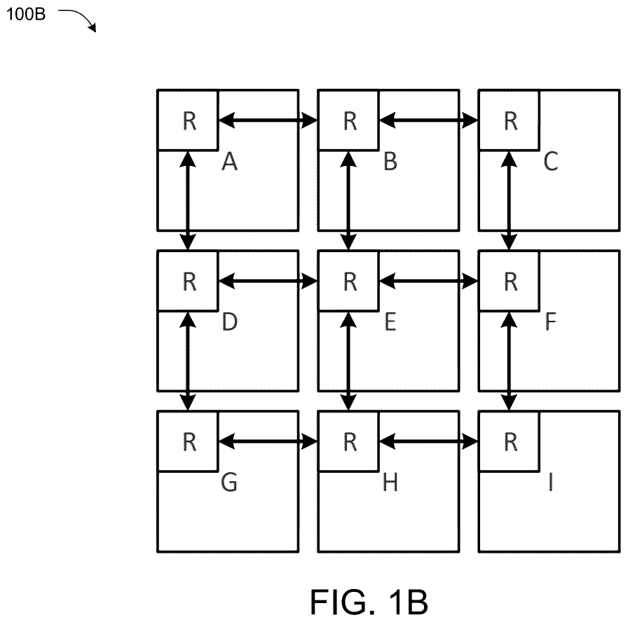

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting.

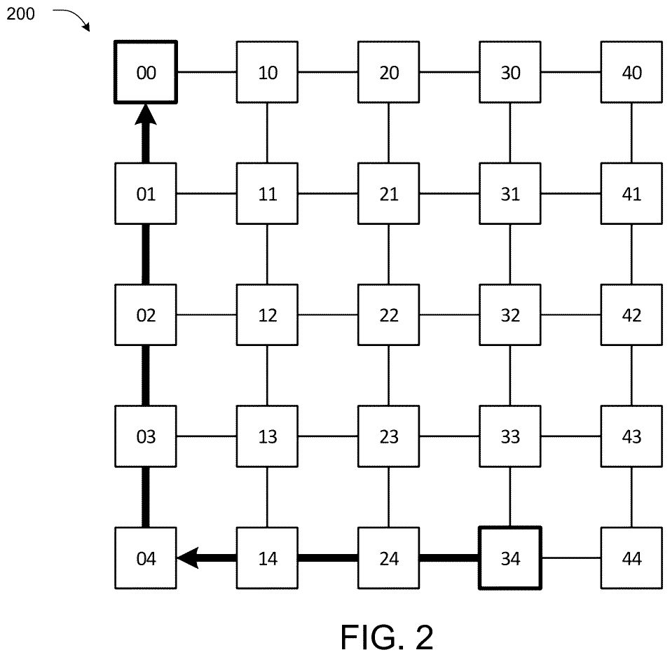

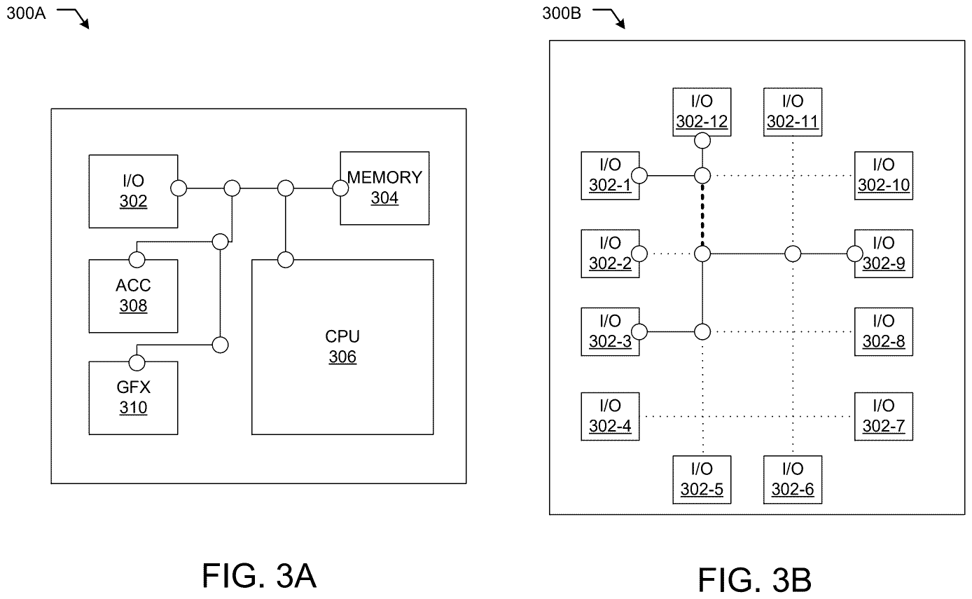

Network-on-Chips (NoCs) are implemented in System-on-Chip (SoCs), switch chips, and the like, but not limited thereto. Example SoC chips and switch chips have been provided in FIGS. 3A and 3B as chips 300A and 300B, respectively. As shown, the SoC chip 300A may include one or more endpoints, such as an input/output (I/O) block 302, a memory 304, and multiple processing elements such as central processing unit (CPU) 306, accelerator 308, graphics (GFX) processing units 310, and the like. Each of the aforementioned elements may be configured to communicate with each other through a NoC having one or more interconnected routers and/or bridges (represented using interconnected circles). Traffic between each of the elements of the SoC chip 300A may be transmitted through the NoC provided therein. Similarly, the switch chip 300B may include one or more endpoints/agents such as a plurality of I/O elements (e.g., I/O elements 302-1 to 302-12, collectively referred as I/O elements 302), which may be configured to communicate through a corresponding NoC defined by NoC elements (such as routers and/or bridges), which are represented using circles in FIG. 3B. The NoC may be configured to ‘fully connect’ the endpoints, to enable bidirectional communication between any two endpoints. While only few routers/bridges of the NoC associated with the switch chip 300B are shown, it may be appreciated that the switch chip 300B may include other routers/bridges that form a structure that is similar to a two-dimensional (2D) mesh (as represented by the dotted lines), which enables communication between any two I/O elements 302. In such cases, typical switch chips 300B may have the corresponding NoC implemented similar to that shown in FIG. 2, and NoC elements thereof may be configured to transport packets using XY and/or YX routing (or other routing schemes such as XYX and/or YXY routing).

In many cases, traffic between one pair of endpoints may be blocked or interfered by traffic between another pair of endpoints. For instance, in case of the switch chip 300B, routes/paths for traffic (i.e., for data packets being transmitted) between I/O elements 302-1 and 302-9, and I/O elements 302-3 and 302-12, may overlap at the region shown using thick dashed lines in FIG. 3B. In such cases, the bandwidth of resources of the NoC (i.e., NoC elements, and links or wires between the NoC elements) at the overlapping regions has to be shared or divided to support the traffic routed therethrough, which increases latency and impacts the performance of the chips. The 2D mesh arrangement of standard/existing NoCs may only lack blocking/interference when two endpoints sharing the same resources carefully control the rates at which they inject traffic, which may require solving difficult coordination problems. Further, existing methods/solutions (such as cross-bar topologies) proposed for obtaining non-blocking properties in a NoC do not scale well for a large number of endpoints. Hence, it is desirable to have paths within the network/NoC between each pair of endpoints that are independent, i.e., paths that do not block or are blocked by traffic between any other pair of endpoints, for maximizing throughput/bandwidth.

Further, some constraints may be unique and/or requirements to the SoC chips (e.g., 300A) and the switch chips (e.g., 300B). For instance, the SoC chips may have compute capabilities (i.e., processing elements configured to compute), while the switch chips may have limited compute. The processing elements configured to provide computing capabilities may be placed in the middle of the SoC chips, while switch chips typically have I/O elements (or other endpoints) at the edges of dies in which the chips are implemented. Accordingly, the SoC chips and switch chips are optimized for a different set of parameters. However, it may be appreciated that in some cases, the switch chips may also be connected to other processing elements, which may be placed internally or externally to the switch chip.

Another requirement for NoCs of switch chips may be maximization of frequency (which is a proxy for bandwidth). A higher frequency may be achieved by minimizing radix (i.e., the number of input ports and output ports communicating with each other in the routers). However, having a lower radix further imposes other constraints on the topology of the NoC. For instance, having lower radixes of NoC elements limits the number of endpoints that the NoC can support, and/or increases the number of other NoC elements required to enable communication between each pair of endpoints. Also, NoCs of SoC chips are optimized for area, as the NoC elements need to fit into gaps provided between the endpoints of the SoC. However, in switch chips, the endpoints may be provided on the edges of the chips, thereby reducing/eliminating considerations with respect to optimization of area of the NoC. Additionally, SoC chips are implemented to have probabilistic traffic (i.e., when traffic is probabilistic), where need for guarantees (for traffic) is low in comparison to switch chips 300B which are implemented to have deterministic traffic (where traffic is definite or known). Accordingly, the design principles or parameters optimized in SoC chips, such as e.g., minimization of NoC traffic, and/or support for traffic under probabilistic conditions, may be different from those of switch chips, which have standard benchmarks that test behavior with deterministic traffic.

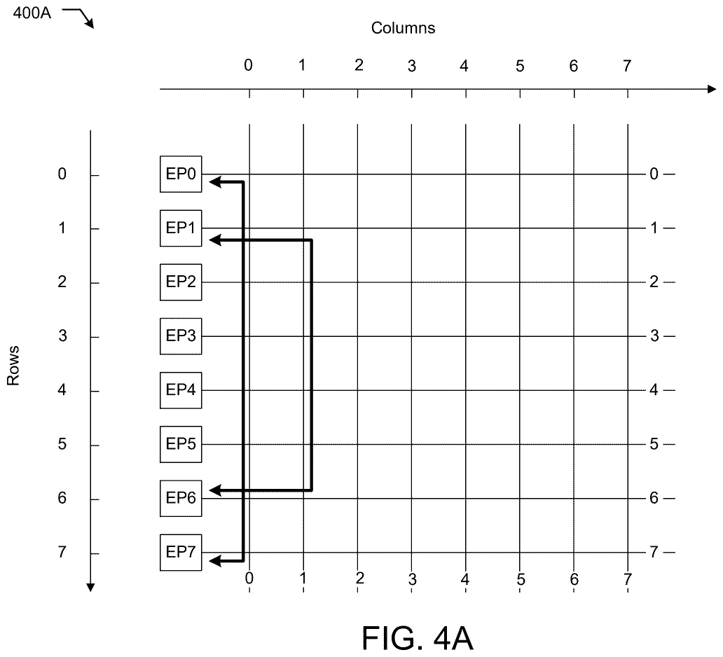

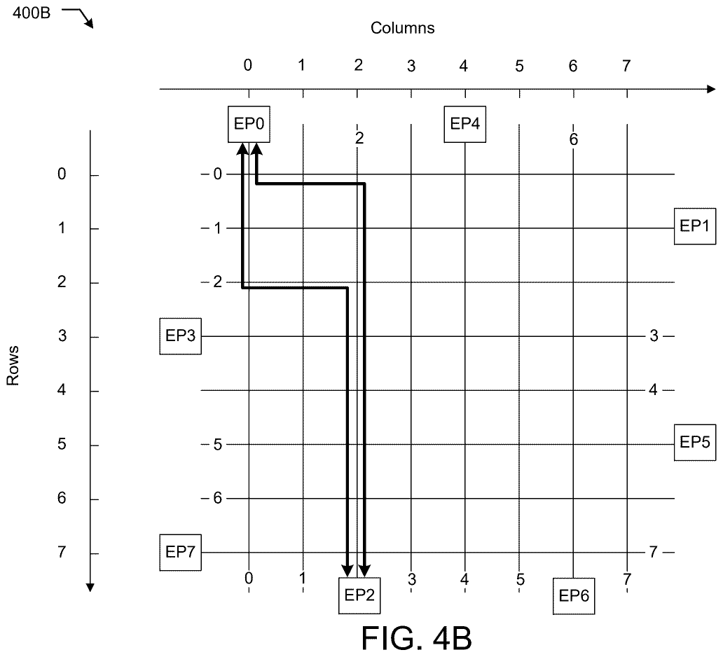

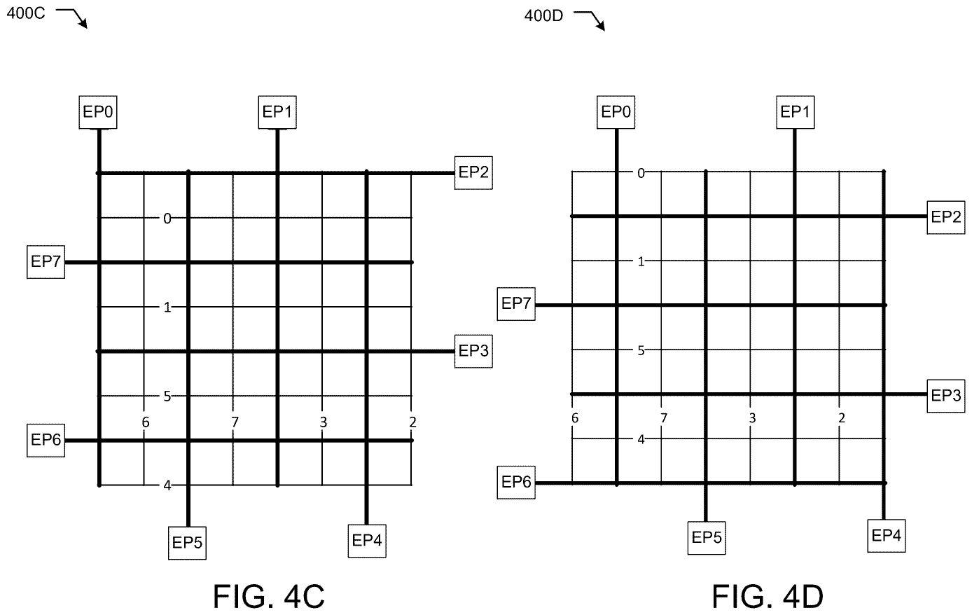

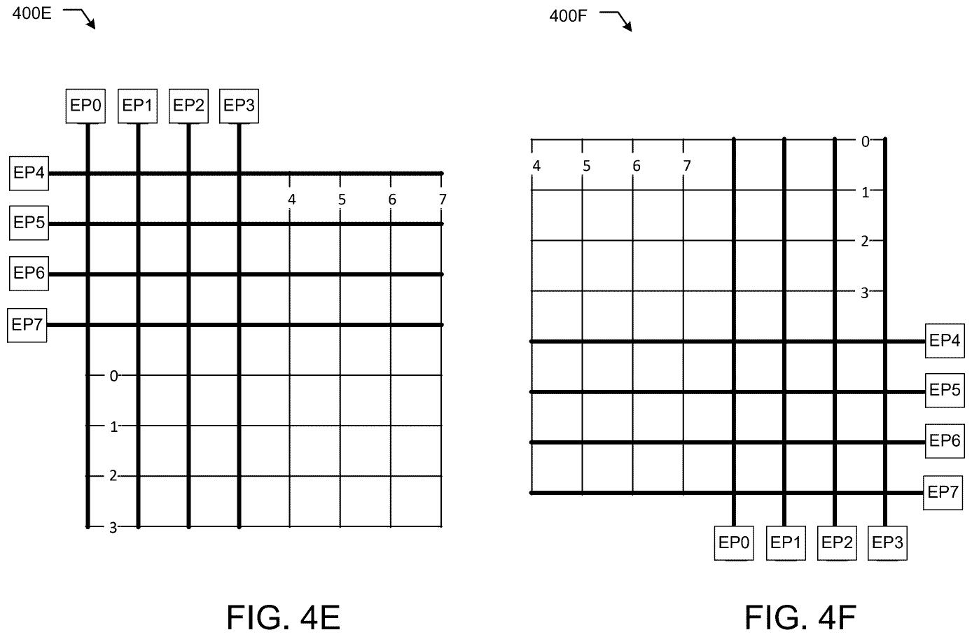

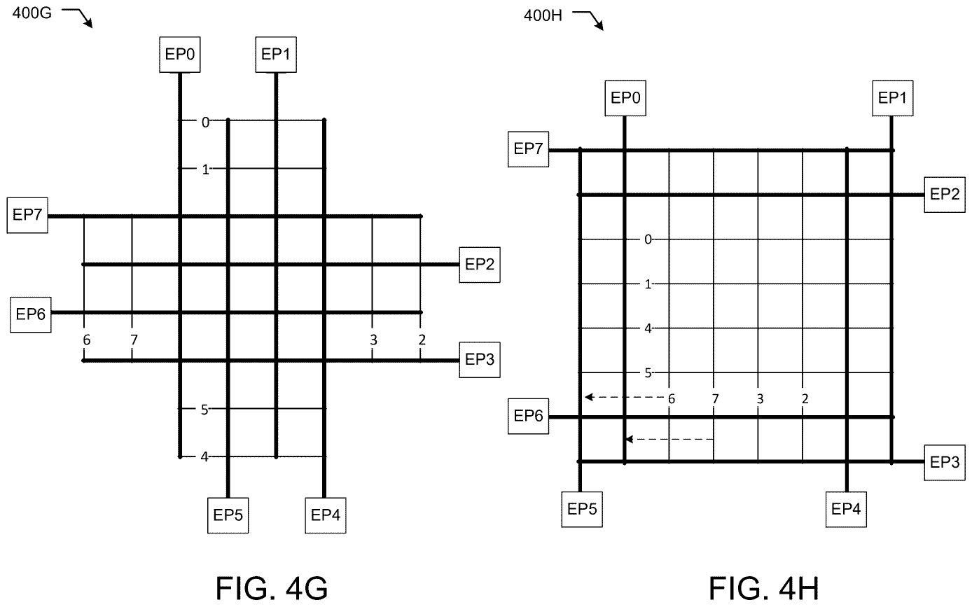

The present disclosure relates to a non-blocking NoC that maximizes bandwidth, and frequency of traffic flow, in a deterministic traffic paradigm, among solving at least the aforementioned problems and/or optimizing for the aforementioned parameters. The present disclosure provides a NoC having a layer, which may include a plurality of routers arranged in a two-dimensional mesh. The two-dimensional mesh may further include a plurality of rows and a plurality of columns (corresponding to NoC resources defined on a NoC coordinate grid). The layer also includes a plurality of bridges, where each of the plurality of bridges exclusively owns at least a subset of links between/connecting the plurality of routers. The subset of links may define a row or a portion thereof from the plurality of rows and/or a column or a portion thereof from the plurality of columns. The traffic from a source bridge of the plurality of bridges to a destination bridge of the plurality of bridges is configured to only travel across the corresponding subset of links exclusively owned by the source bridge and the destination bridge. The ownership applies to the physical links, and/or virtual channels (VCs) of the links. The use of exclusively owned links (i.e., the NoC resources or links along dedicated rows and columns of the coordinate grid) eliminates/minimizes blocking of traffic by other bridges aside from the source bridge and the destination bridge, thereby increasing throughput/bandwidth. Further, the use of cross layer connections allows the use of higher radix routers to greatly reduce latency through the network/NoC without compromising on the non-blocking properties. Various embodiments of the present disclosure are described in detail in reference to FIGS. 4A to 7B.

Referring to FIG. 4A, an example layer/layer instance/layer design 400A of a NoC is shown, having (eight) endpoints EP0 to EP7 disposed on a common edge/side of the layer 400A. The endpoints EP0 to EP 7 may be bidirectionally connected to the layer 400A, i.e., configured to transmit and receive traffic to and from other endpoints. The layer 400A may also include a plurality of wires/links, through which data packets/traffic may be transmitted between any two endpoints. The links may be arranged to form a plurality of rows and a plurality of columns. The solid lines between the endpoints EP0 to EP7 represent the wires/links of the layer 400A through which the traffic may be transported. In some embodiments, the rows and columns may be arranged to form a substantially two-dimensional mesh or a grid topology, however it may be appreciated that the layer 400A may not be limited to such topologies. In some embodiments, routers and/or bridges (not shown) may be placed at intersection points of the wires, to facilitate transmission and change in direction of the traffic, among other functions.

In some embodiments, the bridges/endpoints EP0 to EP7 may exclusively own at least one virtual channel (VC) of the physical links. In some embodiments, different bridges/endpoints may own different VCs of the same physical link. In such embodiments, traffic from the bridges/endpoints may be multiplexed and transmitted through corresponding ‘owned’ VC of common/shared physical links, thereby allowing for fine-grained ownership assignment.

As shown, each of the endpoints EP0 to EP7 are attached to a corresponding row (or a wire/link disposed along the corresponding row (coordinate)) of the layer 400A. In some embodiments, the endpoints EP0 to EP7 may be connected to the row through a corresponding bridge (not shown). In some embodiments, the endpoints EP0 to EP7 (or bridges) may ‘exclusively own’ a subset of links between the routers. The subset of links may include links that form the row and/or column. Throughout the present disclosure, ‘ownership’ indicates the exclusive ‘right’ or ‘authorization’ to use of the link by the corresponding endpoint for transmitting and/or receiving traffic. Ownership of the links by the corresponding endpoint may preclude other endpoints from injecting or receiving of the traffic/data packets through the exclusively owned links. The links in the corresponding columns and rows owned by the endpoints EP0 to EP7 are shown using numbers represented at the edges of the wires. For example, the wires/links along column 0 and row 0 (both labelled as ‘0’) are owned by the endpoint EP0, the wires along column 1 and row 1 (both labelled as ‘1’) are owned by the endpoint EP1, and so on. While the forthcoming embodiments and/or examples show all links of each of the rows and columns being owned by the endpoints, it may be appreciated that the NoC of the present disclosure is not limited such embodiments and/or examples, and may include embodiments where endpoints own links that form a portion of the rows and/or columns.

Typically, when XY or YX routing is used, a first traffic from source endpoint EP0 to destination endpoint EP7 and a second traffic from source endpoint EP1 and destination endpoint EP 6 may be transmitted through shortest paths thereof, which is substantially along the wire along column 0. However, such routing may lead to blocking, as both the first and the second traffic may be in contention with each other to use the wire along column 0. Traffic contentions, for resolution, require the resources (i.e., the bandwidth) to be shared/divided, which increases latency.

Instead, in the layer 400A, the traffic may be transmitted along (the wires/links of) rows and columns exclusively owned by the endpoints supported by the layer 400A (and other layers subsequently described in the present disclosure). For example, the first traffic may be transmitted from the source endpoint EP0 (using a corresponding source bridge) to the destination endpoint EP7 (using a corresponding destination bridge) through the wire/link along column 0 (which is exclusively owned by the source endpoint EP0), i.e., inject the traffic from the source bridge of endpoint EP0 to the wire/router on column 0, then direct the traffic southward to row 7 along the wire/link, and finally eject the traffic to the destination bridge at endpoint EP7. Similarly, the second traffic may be transmitted from the source bridge at the source endpoint EP1 to the destination bridge at the endpoint EP5 through the wires/routers along column 1, row 1, (column 6,) and row 6, which are exclusively owned by the source endpoint EP1 and the destination endpoint EP6. For example, the second traffic may be transmitted in the eastern direction from the source bridge at the source endpoint EP1 through row 1 up to column 1, where the router at the intersection of row 1 and column 1 may direct the traffic in the southern direction up to row 6. Then, the router at the intersection of column 1 and row 6 may direct the traffic in the western direction to eject the traffic to the destination bridge at the destination endpoint EP 6. The paths are shown using thick bidirectional lines in FIG. 4A. As the first traffic predominantly flows through the wires/links along column 0, and the second traffic predominantly flows through the wires/links along column 1, and rows 1 and 6, the first and second traffic may flow without blocking or interference from the other. However, it may be appreciated that other paths may also be used by the first traffic and/or the second traffic, and are not limited to the examples explained above. Hence, the layer 400A has a ‘non-blocking’ property, which improves the bandwidth (utilization), and reduces latency.

While the aforementioned example is described in reference to few of the endpoints as source endpoints and destination endpoints, it may be appreciated that all the endpoints of the layer 400A may be configured to transmit traffic to any other endpoint, and the source endpoints and the destination endpoints are not limited to those identified in the example.

Referring to FIG. 4B, another example layer/layer instance/layer design 400B of a NoC is illustrated, having (eight) endpoints EP0 to EP7 disposed on different edges/sides of the layer 400B. As shown, two endpoints are provided on each of, western side, eastern side, southern side, and northern side of the layer 400B. In some embodiments, the endpoints EP0 to EP7 of the layer 400B may be placed on any position along the rows and/or columns (or the links thereof) that the endpoints own. For example, while the endpoint EP0 is connected to the layer 400A through the wires along row 0 in FIG. 4A, the endpoint EP0 may also be connected to the layer 400B through the column 0 as shown in FIG. 4B, where both row 0 and the column 0 are owned by or dedicated to the endpoint EP0. In some embodiments, enabling the endpoints to be placed on any position along the wires/links of the rows and columns that are exclusively owned by the endpoints may allow the layers/NoCs of the present disclosure to be adapted to other types of chips, including chips having computing capabilities, as described subsequently in reference to FIGS. 4C to 4H.

In some embodiments, multiple paths may be available for communication between any two of the endpoints EP0 to EP7. For example, the endpoints EP0 and EP2 may transmit traffic through at least the subset of links defined along column 0 and row 0 owned by the endpoint EP0 and column 2 and row 2 owned by endpoint EP2. Two paths are shown in FIG. 4B using thick bidirectional lines, which may be taken for transmitting traffic between endpoints EP0 and EP2. Having multiple paths may serve as a fallback mechanism or a recovery mechanism in case of breakages of wires/links or manufacturing defects are present in the wires/links. While some portions of the rows and columns (i.e., wires/links) owned by each of the endpoints may be used/be common for transmitting traffic to other endpoints as well, the assignment and use of exclusively owned wires/links for communication minimizes overlap, thereby improving bandwidth/throughput.

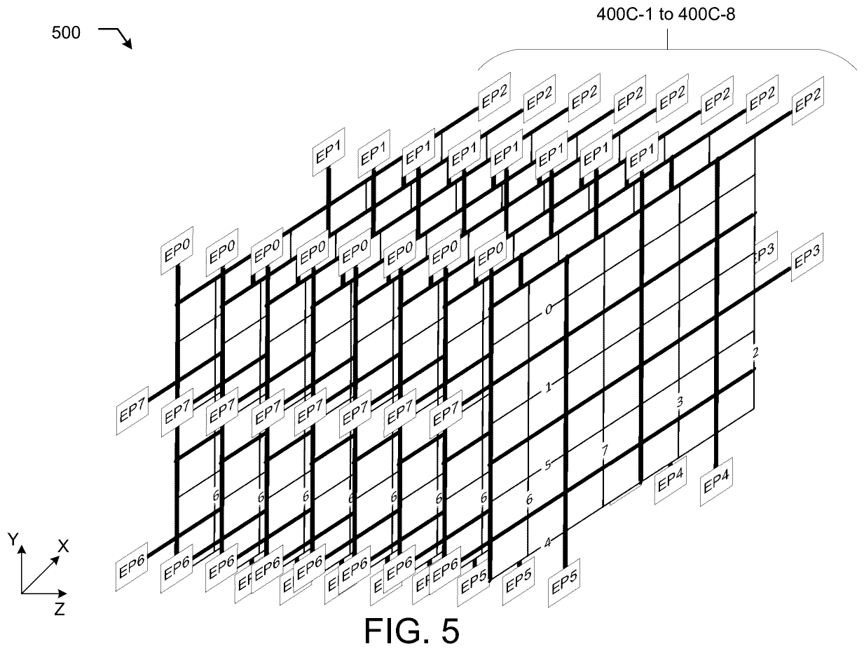

While the links forming the rows and columns owned by the endpoints EP0 to EP7 are arranged sequentially (such as top to bottom, and left to right respectively), it may be appreciated that the links owned by the endpoints EP0 to EP7 may be arranged arbitrarily, as shown in FIGS. 4C to 4H. Further, FIGS. 4C to 4H illustrate different layer designs for the layers. In some embodiments, multiple ones of the layers may be combined/interleaved to form a layer group. In some embodiments, each of the layer groups may include a heterogenous set of the layers implementing layer designs as shown in FIG. 4A to 4H. The layer groups may be stacked or multiply instantiated to form NoCs represented three-dimensionally in FIG. 5.

Referring to FIG. 4C, further example layers 400C of a NoC are shown. The endpoints EP0 to EP7 of the layers 400C may include dedicated (or exclusively owned) links forming at least a portion of the rows and columns, as indicated by bold lines connected to the corresponding endpoints and labelled numerals corresponding to the owning endpoints provided on the wires. As shown, the wires/links owned by each of the endpoints may be arbitrarily arranged, or arranged according to other constraints. For instance, in layers 400C, the links of rows owned by the endpoints EP0 and EP1 may be those proximate to the northern side/edge of the layers, i.e., either wires/links along row coordinates 1 and 3 or row coordinates 0 and 2, respectively, as the endpoints EP0 and EP1 are placed on the northern side. Similarly, the links of columns owned by EP2 and EP3 might be placed closer or proximate to the eastern side/edge, such as wires on column coordinates 6 and 7. Dedicating or providing exclusive ownership to particular links of rows and columns that are physically closer or proximate to the endpoints may reduce/minimize the length of the paths defined for the traffic, between the endpoints on the same side. For example, the paths/routes between endpoints EP0 and EP1 may be shorter when the links owned by the endpoints EP0 and EP1 are at row coordinates 1 and 3, than when the links owned by the endpoints EP0 or EP1 are at row coordinate 7 or 4. In the examples shown in FIGS. 4C and 4D, the links on the nearest available rows and columns are assigned to the endpoints. For instance, since the wires/links on row 0 are owned by the endpoint EP2, the next nearest wire that can be owned by the endpoint EP0 is the wire on row 1. In further embodiments, the endpoints EP0 and EP7 may be placed outside the NoC/layer (as shown in FIGS. 4C to 4H), such that the routers at the edge of the layer receive and/or inject the traffic/packets from the bridges associated with the endpoints through the ports in the direction facing away from the NoC/layer. For example, the northern port of the router at row 0 and column 0 may be connected to the bridge of the endpoint EP0, thereby allowing the radix of the router to remain unchanged.

Referring to FIG. 4D, another layer/layer instance/layer design 400D of a NoC is shown. The layer 400D may have a similar arrangement of endpoints and wires owned by said endpoints as the layer 400C, but represent different chirality thereof. For example, the endpoint EP0 owns column 0 in layer 400C, whereas the endpoint EP0 may own column 1 in layer 400D, and so on.

Referring to FIGS. 4E to 4H, further layers/layer instances/layer designs 400E to 400H, respectively, having different arrangements/topologies are shown. Each of the layers 400E to 400H may have the endpoints thereof arranged on the edges of the NoC such that at least a portion of the layers 400E to 400H may be used to accommodate other processing elements for computation. For example, processing elements (such as accelerators) may be placed on bottom-right portion of the layer 400E or top-left portion of the layer 400F. Further, the processing elements may also be placed on the corners of the layer 400G. In such examples, the length of the columns and/or rows may be reduced. Also, in some examples, a middle portion of the layer (such as layer 400H) may be utilized for placing processing elements, while the dedicated rows and columns are provided on the edges of the layer. Providing space for processing elements/compute may allow the layers/NoC of the present disclosure to be adapted to other kinds of chips, including SoC chips in addition to switch chips or switch chips having computing capabilities, but not limited thereto. In some embodiments, such as those having a similar arrangement to that of the layer 400H, at least some of wires/links corresponding to the rows and columns (associated with the middle portion) may be moved to overlap with wires on other rows and columns at the edges of the NoC/layer 400H. For example, the columns dedicated to endpoints EP6 and EP7 may be moved/overlapped with wires/links on columns 0 and 1, as indicated by the dashed arrows in FIG. 4H. In such embodiments, the routers on the wires/links along columns 0 and 1 may have additional radix.

In some embodiments, the multiple sets of wires/links or lanes may be provided along each of the rows and columns of the layers (such as layers 400A to 400H) of the NoC. Implementing another/multiple sets of wires/links or lanes may allow the layers to extend support to a greater number of endpoints. For example, while eight endpoints are shown in each of the example layers 400A to 400H (i.e., the endpoints EP0 to EP7), having multiple (such as eight) wires/lanes/links may allow multiple endpoints to be located at the positions of the endpoints EP0 to EP7. In such examples, eight endpoints may be placed at each of the positions of endpoints EP0 to EP7 (instead of one), each of which may be configured to use a corresponding wire from the set of wires (i.e., one from the eight wires) that extend along each of the columns and rows. In some embodiments, the NoC may include another (or multiple) layer(s) stacked three-dimensionally, as shown in FIG. 5. In other embodiments, multiple wires and/or endpoints may be provided on the same Z-axis plane, and may be representable three-dimensionally, as shown in FIG. 5. In such embodiments, all the wires/links and/or the endpoints connected to the links may be placed on a 2D mesh.

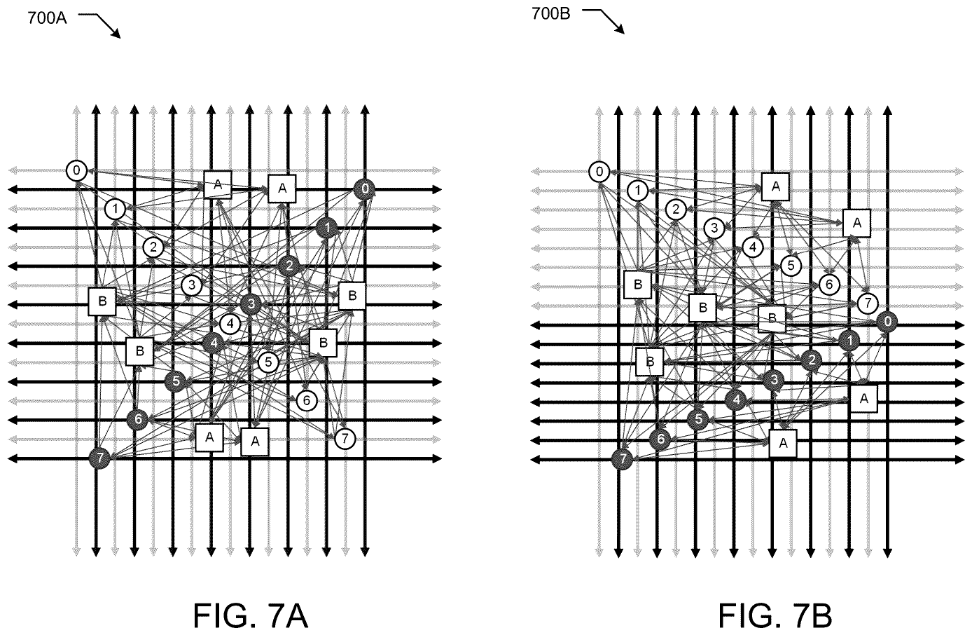

Referring to FIG. 5, a NoC 500 having multiple ones or layer instances of layer design 400C (i.e., layers/layer instances 400C-1 to 400C-8) is shown. However, it may be appreciated that any combination of layers (such as layers 400A to 400N) may be stacked to form the NoC 500. In such embodiments, the NoC 500 may include a homogeneous stack or heterogeneous stack of layers/layer instances. For example, the NoC 500 may include multiple layer instances of layer design 400C and 400D. Similarly, different chirality (such as with respect to placement of the endpoints) of the same layer designs may be instantiated multiple times in the NoC 500. In such embodiments, the heterogenous layers may be implemented within the 2D mesh. In some embodiments, the NoC 500 may be implemented with three-dimensional cube topology (and/or four-dimensional cube topology, in some implementations). In such embodiments, the NoC 500 includes another (seven) layers or layer instances in addition to the layer having dedicated rows and columns. Each of the another layer(s) may be offset by the Z axis from the (first) layer instance, and each other, while all the layers/layer instances of the NoC 500 are defined as planes or two-dimensional meshes on the X and Y axes. The another layer(s) may include another (or a corresponding) plurality of routers arranged in a two-dimensional mesh having another plurality of rows and another plurality of columns, and another (or a corresponding) plurality of bridges. In other embodiments, each of the layers (and multiple instances of the routers, the endpoints, and/or corresponding links thereof) may be provided on the same XY plane. In such embodiments, the layers may be implemented within the 2D mesh, with multiples lanes or instances of the links at each position connecting corresponding multiple instances of the endpoints through corresponding multiple instance of the routers at the same location. Each of the another plurality of bridges may also exclusively own another row from the another plurality of rows and another column from the another plurality of columns. Each wire/lane from the set of wires/lane may be defined on a corresponding layer/layer instance of the NoC 500. Stacking or instantiating multiple ones of the layers (once inter-layer communication is enabled between the layers as described subsequently in the present disclosure) preserves the non-blocking property of the layers/layer instances, while also supporting a greater number of endpoints. In some embodiments, multiple layer instances (such as layer designs 400C and 400D) may be combined and provided at the same Z axis. For example, the layers 400C and 400D may be combined to form topologies as shown in FIGS. 7A and 7B.

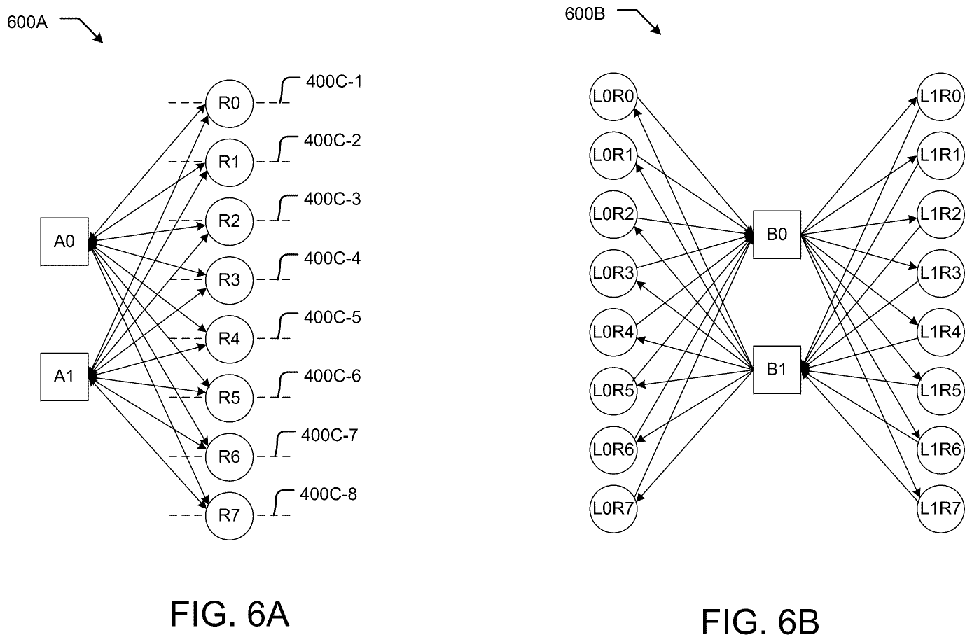

While the endpoints at each layer may be configured to communicate with each other in a non-blocking manner, the NoC 500 may require additional elements that support communication between endpoints of different layers/layer instances. In some embodiments, additional NoC resources (i.e., wires and routers) may be provided for inter-layer communication. In some embodiments, the layer and the another layer(s) may be connected by a cross-layer router (shown as ‘A’ and ‘B’ in FIGS. 6A and 6B) configured to send traffic between the layer and the another layer to communicate between source and destination on different layers. The additional NoC resources (i.e., the cross-layer routers) may provide paths along the Z axis for inter-layer communication. In some embodiments, the cross-layer routers may be connected to the routers of the layer/another layer through cross-layer links. In some embodiments, each of the cross-layer links may be owned by at least one of the endpoints/bridges. Hence, the subset of links exclusively owned by the endpoints/bridges may include the cross-layer links.

Referring to representation 600A shown in FIG. 6A, a (first-type) cross-layer routers (such as cross-layer routers A0 and A1) may be bidirectionally connected to each of the 8 layers (i.e., the layers/layer instances 400C-1 to 400C-8) of the NoC 500. In some embodiments, the cross-layer routers may have a radix of 8 by 8, i.e., 8 input ports to receive traffic from each of the layers and 8 output ports to eject the traffic to each of the layers. In such embodiments, the cross-layer routers may be configured to provide full bandwidth between each of the layers of the NoC. For example, referring back to FIGS. 4C and 5, and FIG. 6A, the endpoint EP0 in layer/layer instance 400C-1 may transmit (or be required to transmit) packets/traffic to endpoint EP3 in layer/layer instance 400C-7. The traffic may be routed from the endpoint EP0 in layer 400C-1 in the southern direction up to a first router where the traffic needs to perform its first turn (such as up to the first router at row coordinate 4 and column coordinate 1). From the first router, the traffic may be routed through the cross-layer router A0. The cross-layer router A0 may be configured to direct the traffic from the first router to a second router in layer 400C-7. The first router and the second router may be overlapping with respect to the X and Y axes; however, it may be appreciated that in other embodiments, the first router and the second router may not be aligned/overlapping along the Z axis. The second router may be configured to direct the traffic in the eastern direction, until the traffic reaches a third router at column 7. The traffic may then be ejected to the endpoint EP3 at layer/layer 400C-7, through the destination bridge associated with the endpoint EP3.

In some embodiments, multiple cross-layer routers may be provided for preserving the non-blocking property of traffic flow between the endpoints of different layers. For instance, while the endpoint EP0 of layer 400C-1 is transmitting traffic to the endpoint EP3 of layer 400C-7, the endpoint EP3 of layer 400C-7 may also transmit traffic to the endpoint EP0 of layer 400C-1. In such instances, the endpoints EP0 and EP3 may compete for bandwidth. Further, if a traffic along that path needs to switch to a particular layer/layer instance, in both directions, one router may only have one port going to that layer/layer instance, leading to situations where the traffic compete/contend to use that port. Also, when traffic from endpoints in the same layer are to transmit traffic to different layers, there is only one link going through that cross-layer router. To preserve non-blocking, multiple ones of the cross-layer routers may be provided (such as cross-layer routers A0 and A1). In some embodiments, the endpoints may be configured to transmit traffic through one of the cross-layer routers, and receive traffic from other endpoints through the other cross-layer router. For example, while the endpoint EP0 of layer 400C-1 may transmit traffic to the endpoint EP 3 of layer 400C-7 through the cross-layer router A0, the endpoint EP3 of layer 400C-7 may transmit traffic to the endpoint EP0 of layer 400C-1 through the cross-layer router A1, thereby also preserving non-blocking property of the NoC 500.

While the foregoing example (i.e., with respect to NoC 500) supports up to 64 endpoints (i.e., 8 endpoints in each of the 8 layers), the number of endpoints supportable by the NoC 500 may be further extended by combining different arrangements/topologies of the layers on each XY plane/Z axis coordinate of the NoC 500. For example, the layers 400C and 400D may be combined such that each layer/plane of the NoC 500 supports 16 endpoints, as shown in FIGS. 7A and 7B. The endpoints of the layer 400C may be placed on even coordinate values/positions, while the endpoints of the layer 400D may be placed/positioned on odd coordinate vales/positions of the NoC 500, to combine the instances of layers 400C and 400D on a single/common plane. In such examples, the total number of endpoints supported on the NoC 500 may be 128, i.e., 16 endpoints in each of the 8 XY planes. Further, both layers 400C and 400D in each XY plane may be combined/merged/arranged such that the diameter of the NoC 500 remains unchanged, i.e., the diameter may remain 8×8 which reduces latency. For comparison, existing switch chips may require NoCs having 128 rows and 128 columns to support 128 endpoints, and may require longer paths with many hops for communication of traffic between any two endpoints.

However, the layers associated with each XY plane of the NoC 500 may also require dedicated routers for inter-layer communication (i.e., for layers/layer instances on the same plane). In such embodiments, additional cross-layer routers configured to receive traffic from endpoints of one layer/layer instance and redirect/transmit the traffic to endpoints in another layer/layer instance within the same plane, may be provided on the layers/layer instances of the NoC. In such embodiments, the cross-layer router may be unidirectional.

Referring to representation of 600B shown in FIG. 6B, the NoC 500 may include two (second-type) cross-layer routers B0 and B1 to enable inter-layer communication between layers/layer instances on the same plane/Z coordinate. The cross-layer router B0 may be configured to receive traffic from the endpoints associated with a first layer through corresponding routers (the routers of the first layer being labelled L0R0 to L0R7), and redirect the traffic to endpoints associated with a second layer through corresponding layers thereof (i.e., the routers of the second layer being labelled as L1R0 to L1R7). The cross-layer router B0 facilitates communication from the endpoints of the first layer to the endpoints of the second layer. Similarly, the cross-layer router B1 may be configured to receive traffic from the endpoints associated with the second layer through corresponding routers, and redirect the traffic to endpoints associated with the first layer through corresponding routers thereof. The cross-layer router B1 may facilitate communication from the endpoints of the second layer to the endpoints of the first layer, thereby enabling communication between any two endpoints while also preserving the non-blocking property of the NoC.

In other embodiments, the cross-layers routers B0 and B1 may also be bidirectional. In such embodiments, the radix of such cross-layer routers may be increased (such as from 8 to 16).

In some embodiments, the cross-layer routers (i.e., both the first-type and the second cross layer routers) may be external to the plurality of routers and the another plurality of routers associated with each of the layers of the NoC. In such embodiments, dedicated cross-layer routers may be used for inter-layer communication, which may be separate or physically external to the routers in the rows and columns of the layer. In other embodiments, the cross-layer routers may be formed from routers from the plurality of routers and the another plurality of routers, which are associated with each of the layers of the NoC. In such embodiments, at least some of the routers in the layers of the NoC may be repurposed for inter-layer communication. In some embodiments, the routers of different layers on the same plane may merge into a single router (i.e., the internal router), which allows traffic to be moved between layers. In such embodiments, the radix of the single router may be greater than those of the other routers of the layers. The radix for the internal cross-layer routers may be determined/selected/defined based on the number of endpoints, and/or the number endpoints in the layer. In some embodiments, both the first-type cross-layer router and the second-type cross-layer router may be provided at every intersection of wires or grid cross-points of the NoC.

Referring to FIGS. 7A and 7B, consolidated NoC layers 700A and 700B, respectively, are shown. Each of the NoC layers 700A and 700B may be configured to combine/interleave the layer (designs) shown in FIGS. 4A to 4H. The layers may be interleaved in the same 2D mesh forming the layer. In some embodiments, the layers may be heterogenous. For example, the NoC layer 700A combines the layer designs 400C and 400D. In NoC layers 700A, links of the instantiations of the layer design 400D are shown using grey color bidirectional lines, and links of the layer design 400C are shown using black color bidirectional links. However, it may be appreciated that the arrangement of the links/wires of the layer (designs) may be combined and/or suitably adapted arbitrarily, based on requirements and/or constraints of the use case. For example, NoC layer 700B shows another arrangement of the routers and wires. In both the NoC layers 700A and 700B, routers of the first layer design instance are shown using circles having white background and black text, and routers of the second layer design instance are shown using circles having black background and white text.

Each of the NoC layers 700A and 700B have an 8×8 mesh with 64 cross points. At each of the cross points of each layer (700A and 700B), eight routers may be provided (corresponding to each of eight planes or Z axis coordinates associated with the NoC). Further, the NoC layers 700A and 700B may include cross-layer routers at each cross point. The first-type/Z axis cross-layer routers are represented as ‘A’. At least two Z axis cross-layer routers may be provided for communication between each of the layer design instances that are separated on the Z axis coordinate. Further, the second-type cross-layer routers represented as ‘B’ may be used for communication between the layer design instances on the same plane/Z axis coordinate. As shown, four second-type cross-layer routers may be provided, two for traffic between the first layer design instantiation to the second layer design instantiation, and two for traffic between the second layer design instantiation to the first layer design instantiation. Hence, at each location/grid cross point, a total of 24 routers may be provided, i.e., 8 routers of the first layer design instantiation and 8 routers of the second layer design instantiations (which may be distributed across planes across the Z axis), 4 first-type cross-layer routers, and 4 second-type cross-layer routers.

As stated, each of the cross-layer routers of the NoC layers 700A and 700B may be radix 8 routers, as each cross-layer router may have 8 input ports and 8 output ports (for receiving and transmitting traffic from and to each of the 8 layers). Further, other routers in the cross-point may also have a radix of 8, i.e., 4 directional input and output ports for directing the traffic in each of the fourth (i.e., north, south, east, and west directions), two input and output ports for bidirectional communication with two first-type cross-layer routers, and two input ports each for both the second-type cross-layer routers from which traffic is received, and two output ports each for both the second-type cross-layer router to which the traffic is transmitted. The arrangement of the routers and the cross-layer routers also allows for the radix to be bounded (i.e., bounded to 8 in the foregoing examples), which increases frequency and lowers latency. Further, the ownership of the wires along dedicated rows and columns allows the endpoints to communicate in a non-blocking manner (i.e., minimizing the overlap of paths taken by all pairs of endpoints in the NoC).

It may be appreciated that the NoC of the present disclosure may not be limited to the aforementioned examples, where each of the routers have a radix of 8. Instead, the examples and/or embodiments of the present disclosure may be suitably adapted for NoC design the routers have a radix of greater than or less than 8. In some implementations where the radix is greater than 8, more layer designs may be combined/merged on each plane to expand the NoC layers, such as to 16×16 meshes or 32×32 meshes. Such decisions may be made based on requirements and/or constraints of the use case.

Hence, the present disclosure provides a NoC having layers with rows and columns exclusively owned by endpoints (or bridges thereof), through which traffic/data packets between the corresponding endpoint and other endpoints are exclusively transmitted. The ownership of the rows and columns may provide the layers of the NoC with non-blocking properties, which increases bandwidth and reduces latency. Further, the present disclosure provides designs for expanding the NoC to support further endpoints, by allowing the non-blocking layers to be instantiated multiple times, and combined with other layers/layer instances, while to preserve the non-blocking property of the layers by using cross-layer routers. The present disclosure allows for expansion of the NoC without increasing the radix of the routers, thereby improving frequency of the routers to minimize the NoC resources required for supporting the increased number of endpoints.

Furthermore, some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example embodiments, the steps carried out require physical manipulations of tangible quantities for achieving a tangible result.

Moreover, other implementations of the example embodiments will be apparent to those skilled in the art from consideration of the specification and practice of the example embodiments disclosed herein. Various aspects and/or components of the described example embodiments may be used singly or in any combination. It is intended that the specification and examples be considered as examples, with a true scope and spirit of the embodiments being indicated by the following claims.

What is claimed is:

1. A Network on Chip (NoC), comprising:
a layer, comprising:
a plurality of routers arranged in a two-dimensional mesh; and
a plurality of bridges, wherein each of the plurality of bridges exclusively owns at least a subset of links between the plurality of routers;
wherein traffic from a source bridge of the plurality of bridges to a destination bridge of the plurality of bridges is configured to only travel across the corresponding subset of links exclusively owned by the source bridge and the destination bridge.

2. The NoC of claim 1, further comprising:
another layer, comprising:
another plurality of routers arranged in a two-dimensional mesh; and
another plurality of bridges, wherein each of the another plurality of bridges exclusively owns another subset of links between the another plurality of routers;
wherein the layer and the another layer are connected by a cross-layer router configured to send traffic between the layer and the another layer to communicate between source and destination on different layers.

3. The NoC of claim 2, wherein the cross-layer router is external to the plurality of routers and the another plurality of routers.

4. The NoC of claim 2, wherein the cross-layer router is formed from routers from the plurality of routers and the another plurality of routers.

5. The NoC of claim 2, wherein the cross-layer router comprises unidirectional and/or bi-directional routers.

6. The NoC of claim 2, wherein the layer and the another layer are heterogenous.

7. The NoC of claim 1, wherein the two-dimensional mesh comprises a plurality of rows and a plurality of columns being at least partially defined by the subset of links.

8. The NoC of claim 7, wherein at least a portion of the plurality of rows and the plurality of columns is owned by different routers of the plurality of routers.

9. The NoC of claim 2, wherein the subset of links comprises cross-layer links of the cross-layer router that connects the layer and the another layer.

10. The NoC of claim 1, wherein the plurality of bridges exclusively owns at least one virtual channel of the subset of links.
